(19) United States
(12) Patent Application Publication
(10) Pub. No.: US 2018/0286232 A1
(43) Pub. Date: Oct. 4, 2018

(54) TRAFFIC CONTROL USING SOUND SIGNALS

(71) Applicant: David Shau, Palo Alto, CA (US)

(72) Inventor: David Shau, Palo Alto, CA (US)

(73) Assignee: David Shau, Palo Alto, CA (US)

(21) Appl. No.: 15/820,287

(22) Filed: Nov. 21, 2017

Related U.S. Application Data
(63) Continuation-in-part of application No. 15/476,806, filed on Mar. 31, 2017.

(51) Int. Cl. G08G 1/0962; G01S 13/50; G01S 15/93; H04W 4/04; G06F 17/30

(52) U.S. Cl. CPC G08G 1/09623; G01S 13/505; G06F 17/30758; H04W 4/046; G01S 15/931

(57) ABSTRACT

Methods for vehicle to vehicle communication, vehicle detection, and vehicle to traffic sign communication are devised. Such methods can involve the use of one or a plurality of speakers to emit artificial sound signals, as well as the use of one or a plurality of sound detectors to record artificial or natural sound signals emitted by nearby vehicles or traffic signs. The use of an active sonar system will also allow autonomous vehicles to detect nearby surroundings. The Doppler Effect can also be used to determine the speeds of moving vehicles. These methods allow autonomous vehicles to drive and respond to their surroundings, and also allow traffic signs to respond to various traffic situations by detecting the presence of nearby vehicles.

This application is a continuation-in-part application of previous patent application with a Ser. No. 15/476,806, with a title “Mobile phones with Warnings of Approaching Vehicles”, and filed by David Shau on Mar. 31, 2017.

### BACKGROUND OF THE INVENTION

The present invention relates to traffic control systems that detect nearby traffic conditions using sound signals.

A mobile phone is a portable telephone that can make and receive calls over a radio frequency link while the user is moving within a telephone service area. In addition to telephone functions, mobile phones also possess multiple other functions. For example, a mobile phone can be used to text, browse the internet, play video games, take pictures, record videos, play music, and set alarms. Ever since the rise of smartphone technology, it has been a commonality to see individuals using their mobile phones at almost any location. However, this usage often distracts the user from outside stimuli, and can be dangerous in areas with fast moving vehicles. According the studies performed by Ohio State University, the percentage of pedestrians killed while using cell phones has risen by 2.5% from 2004 to 2010. Although nearly everyone has been warned about the dangers of texting while driving, using mobile phones while walking is still an underrated issue, and a less scrutinized safety hazard.

It is therefore desirable to have a method in which pedestrians can be warned of approaching vehicles while they are using a mobile phone. Such warnings should be given by the mobile phone while it is in use, and should clearly indicate the general location or direction of the incoming vehicle. This method of warning pedestrians of incoming vehicles while they are using a mobile phone serves to make pedestrians more aware of their surroundings, thereby decreasing the chance for pedestrian-vehicle accidents to occur.

This application is a continuation-in-part application of previous patent application with a Ser. No. 15/476,806, and filed by David Shau on Mar. 31, 2017. The previous patent application focuses on mobile devices that provide warnings of dangerous traffic conditions by detecting natural noises emitted by nearby vehicles. This patent application provides additional features using sound signal analysis by automobiles and traffic signs. Automobiles described in this patent application can be vehicles driven by human drivers or autonomous vehicles. Prior art autonomous automobiles rely on image processing to detect traffic conditions. However, video images can be blocked by snow, fog, dust, rain, darkness, or tree branches. In contrast, sound signals can penetrate through those barriers, and will not be obstructed. Image processing is also significantly more expensive than sound analysis. Other prior art methods for automobile communication rely on electromagnetic waves. Sound signals provide additional effective communication channels.

For the present invention, the term “traffic signs” encapsulates all types and variations of signs used to facilitate traffic, such as stop signs, yield signs, speed limit signs, warning signs, street name signs, traffic lights, road signs, rail road signs, highway exit and entrance signs, highway direction signs, construction signs, construction cones, and roadblocks. Communication using sound signals can significantly improve the functions of traffic signs.

### SUMMARY OF THE PREFERRED EMBODIMENTS

A primary objective of the preferred embodiments is, therefore, to provide warnings of incoming vehicles for pedestrians when the they are using mobile phones. Another primary objective of the preferred embodiments is to detect nearby traffic conditions for automobiles using sound signals. Another objective is to distinguish what kind of vehicle is approaching the pedestrian, automobiles, or traffic signs. Another objective is to differentiate mild and severe warnings by measuring the speed that the incoming vehicle is traveling. Another objective is to provide the relative location and direction of the incoming vehicle or traffic signs, so that the pedestrian or automobile will know where to expect danger. Another objective is to estimate the distance of an incoming vehicle from the pedestrian. These and other objectives can be achieved by analyzing the sounds detected by one or a plurality of microphones in mobile phone devices, automobiles, or traffic signs.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) is a symbolic diagram that shows an individual using a mobile phone approaching an intersection;

FIG. 1(b) is a simplified symbolic diagram illustrating a bird's-eye-view of the traffic around the individual in FIG. 1(a);

FIGS. 2(a, b) show exemplary on-screen displays of the mobile phone in FIG. 1(a);

FIG. 2 (c) is a symbolic block diagram illustrating the structures of the mobile phone in FIGS. 2(a, b);

FIG. 3(a) is a simplified symbolic diagram illustrating vehicle noise detection using one microphone;

FIG. 3(b) is a simplified symbolic diagram illustrating vehicle noise detection using two microphones;

FIG. 4 is a flow chart illustrating exemplary procedures for one embodiment of the present invention;

FIG. 5(a) is a symbolic diagram that shows the traffic conditions near an intersection;

FIG. 5(b) is a simplified symbolic diagram illustrating a bird's-eye-view of the traffic in the intersection in FIG. 5(a);

FIGS. 6(a-c) are simplified symbolic diagrams illustrating automobile to automobile communications using sound signals;

FIGS. 6(d-f) are simplified symbolic diagrams illustrating automobile to traffic sign communications using sound signals;

FIGS. 7(a-c) are simplified flow charts illustrating sound analyses that can be used by the automobiles in FIGS. 6(a-c); and

FIG. 7(d) is a simplified flow chart illustrating a method of sound analysis that can be used by the traffic signs in FIGS. 6(d-f).

### DETAILED DESCRIPTION OF THE PREFERRED EMBODIMENTS

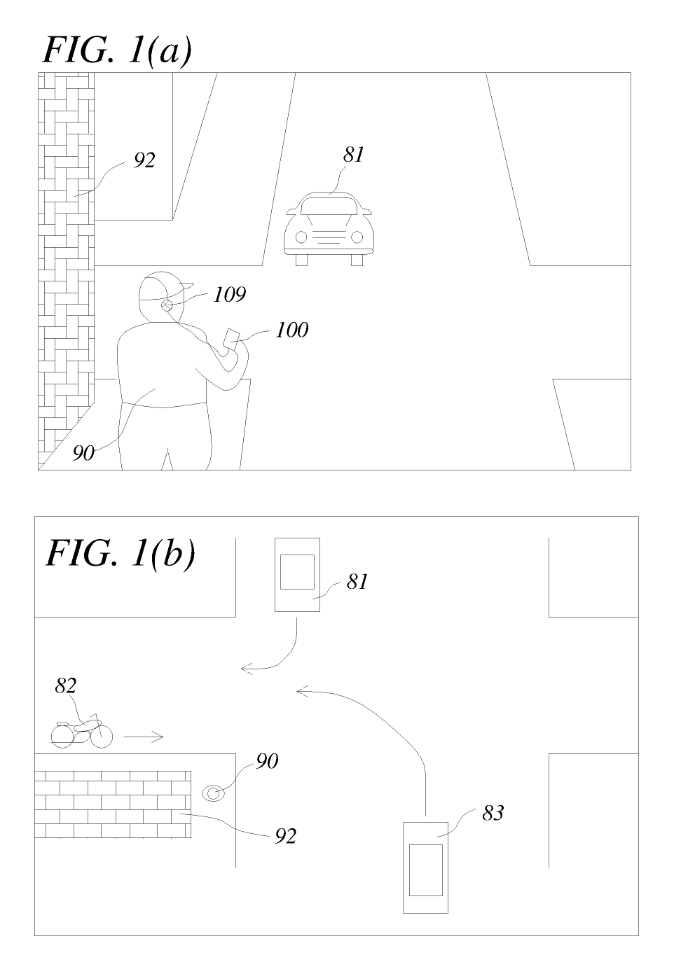

FIG. 1(a) shows a scenario where an individual (90) is walking towards an intersection while being distracted by his mobile phone (100). He is listening to music with headphones (109), and is playing a video game on his mobile phone (100). While he is aware of the parked car across the street (81), this individual (90) is being distracted by his mobile phone (100), and is unaware of other threats in the vicinity.

FIG. 1(b) is a simplified symbolic diagram illustrating a bird's-eye-view of the traffic around the individual (90) in FIG. 1(a). A building (92) blocks the view of a speeding motorcycle (82) quickly approaching from the individual's left. Normally, the noise of the approaching motorcycle (82) should be able to alarm the individual (90), but his music (109) and video game prevents him from noticing the sounds of the motorcycle. In addition, a car behind the individual (83) is approaching the intersection with the intent of making a left turn. Furthermore, the owner of the parked car (81) has just turned on the engine, and is planning on turning right, as illustrated by the arrows in FIG. 1(b). Distracted by the video game and music provided by his mobile phone (100), the individual (90) is unaware of the dangers around him, and a collision is bound to occur.

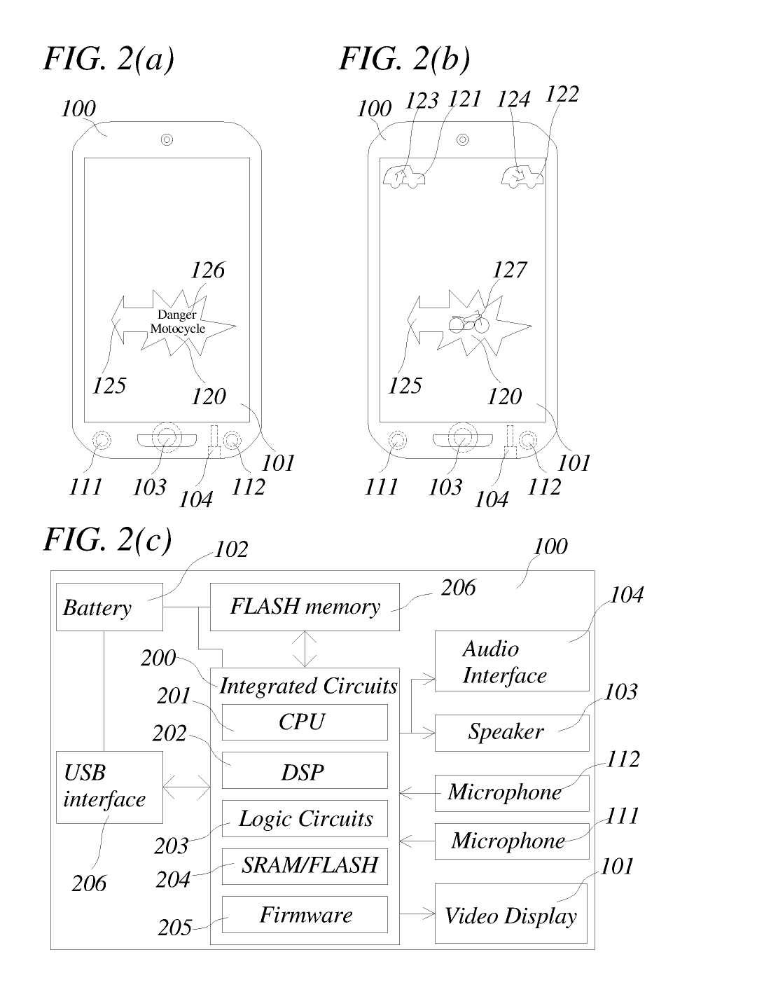

Fortunately, the individual (90) is using an embodiment of the present invention. As illustrated in FIG. 2(a), the microphones (111, 112) in the mobile phone (100) detect sound emitted by the motorcycle (82) in FIG. 1(b). The integrated circuits (200) in the mobile phone (100) provide digital signal processing capabilities to analyze the sound signals, and provide an audio warning for the individual (90) through a sound speaker (103) in the mobile phone (100). The audio warning also can be provided to the earphones (109) that are connected to the mobile phone (100) through an audio interface, which can include, but is not limited to, headset sockets or Bluetooth interfaces (104). The audio warning messages temporarily overlap with or overwrite the normal audio that the mobile phone is playing so that the user (90) is alerted. In addition, a warning icon (120) is displayed on the visual display (101) of the mobile phone (100). This warning icon (120) temporarily overlaps or overwrites parts of the normal visual display of the video game that the individual (90) is playing, and distinguishes the most dangerous threat. In this case, the threat is the motorcycle approaching on the individual's left; the warning icon (120) indicates the direction of the threat with an arrow (125), and shows the type of vehicle by text (126).

Alternatively, FIG. 2(b) shows another method for displaying warnings. The mobile phone (100) displays a warning icon (120) with an arrow (125) to indicate the direction of the vehicle in similar ways as the example shown in FIG. 2(a), but it displays a graphic symbol (127) of the kind of vehicle that is approaching. In addition, the mobile phone can distinguish sound signals coming from different vehicles, estimate the number of vehicles approaching, and provide warnings of other potential dangers. For the example in FIG. 2(b), the mobile phone (100) displays warning icons (121, 122) that indicate what other kinds vehicles are approaching nearby. These warning icons (121, 122) also indicate the direction of such incoming vehicles with arrows (123, 124). In this case, the warning icons (121, 122) and arrows (123, 124) correspond to the car in front of the individual (81) and the car behind the individual (83).

FIG. 2(c) is a symbolic block diagram illustrating the structures of the mobile phone (100) in FIGS. 2(a, b). This mobile phone (100) is controlled by a plurality of integrated circuits (200), which comprise a Central Processing Unit (CPU) (201), a Digital Signal Processing (DSP) unit (202), logic circuits (203), memory devices (204) such as Static Random Access Memory (SRAM) devices and/or nonvolatile memory devices (FLASH), firmware (205), and other integrated circuits. Those functional units (201-205) may be integrated into one integrated circuit chip, or implemented in a plurality of integrated circuit chips. A separate FLASH memory (206) can be used to store more data and more software or firmware. In this example, the mobile phone (100) has two microphones (111, 112), but can also have only one microphone or more than two microphones. Audio outputs can be played using a speaker (103) or earphones connected to the audio interface (104) of the mobile phone (100). Images are displayed on a visual display (101). A battery (102) provides electrical power to those electronic components. The battery (102) can be charged through a Universal Serial Bus (USB) interface (206). The USB interface (206) also provides communication channels with other electronic devices such as computers.

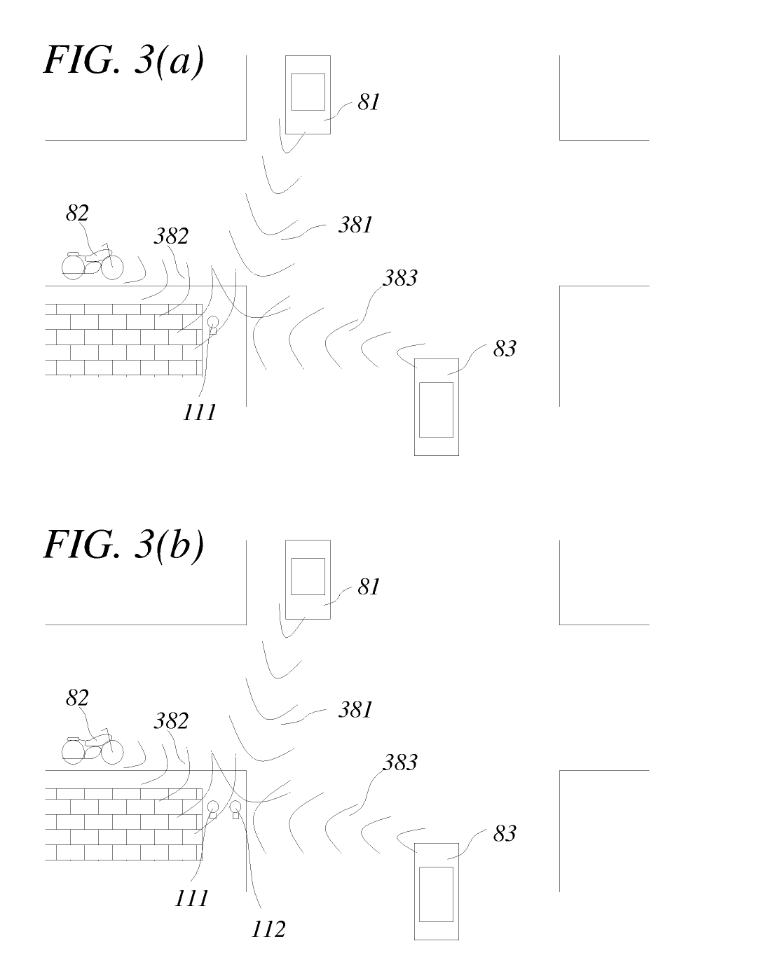

FIG. 3(a) shows a simplified symbolic view of a microphone (111) in the mobile phone (100) recording the sound waves emitted by the motorcycle (382), the car in front of the individual (381), and the car behind the individual (383). The sound waves that a vehicle emits come from engine noise, emission noise, tire friction, air friction, and other sound sources. Different types of vehicles have different noise patterns. The noise pattern of the sound waves emitted by the motorcycle (382) is different than that of cars. The noise pattern of the sound waves (381) emitted by the car in front (81) is also different than that of the sound waves (383) emitted by the car behind (83). The volume and the spectrum of vehicle sound signals can be used to estimate speed, distance, and direction of the vehicle. Because the hardware, software, and firmware of the mobile phone in FIG. 2(c) can recognize human voices, the same functions can also be used to analyze the vehicle sound signals recorded by the microphone (111).

While the preferred embodiments have been illustrated and described herein, other modifications and changes will be evident to those skilled in the art. It is to be understood that there are many other possible modifications and implementations so that the scope of the invention is not limited by the specific embodiments discussed herein. The example shown in FIG. 3(a) uses sound signals detected by one microphone (111) to analyze traffic conditions. FIG. 3(b) shows an example that uses two microphones (111, 112) in a mobile phone for traffic condition analysis.

Due to the finite speed of sound waves, the sound waves (381-383) emitted by vehicles (81-83) reach the microphones (111,112) at different times. For example, the sound waves (382) emitted from the motorcycle (82) arrive at the first microphone (111) earlier than they arrive at the second microphone (112); the sound waves (383) emitted from the car behind (83) arrive at the first microphone (111) later than they arrive at the second microphone (112); the sound waves (381) emitted from the car in front (81) arrive at the first microphone (111) slightly later than they arrive at the second microphone (112). By comparing the differences between the sound signals detected by different microphones (111, 112), the mobile phone can estimate the speed, distance, and direction of nearby vehicles, as well as other information relating to the nearby vehicles. Typically, the use of more microphones results in higher accuracies.

While the preferred embodiments have been illustrated and described herein, other modifications and changes will be evident to those skilled in the art. It is to be understood that there are many other possible modifications and implementations so that the scope of the invention is not limited by the specific embodiments discussed herein.

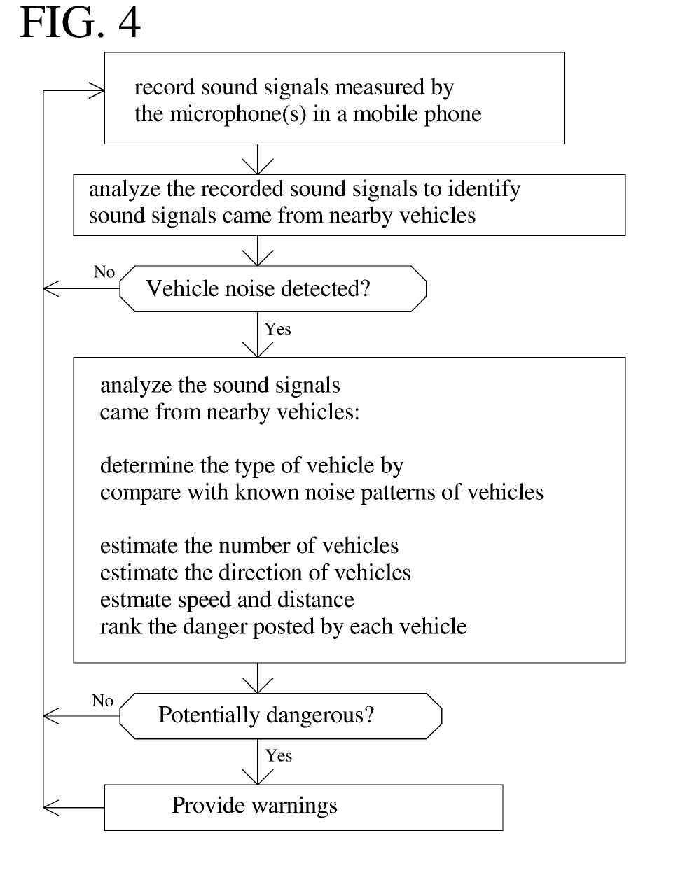

FIG. 4 is a flow chart illustrating exemplary procedures for one embodiment of the present invention. The sound signals measured by one or more microphones in a mobile phone are recorded in the mobile phone. These recorded sound signals may come from many sources such as the voice of the user, noises from nearby shops, and noise emitted by nearby vehicles. It is necessary to use the signal processing capabilities of the mobile phone to distinguish the vehicle sounds in the recording from all other background noises. If vehicle noises are detected, the next step would be to analyze the sound signals emitted by a nearby vehicle or vehicles to detect potentially dangerous situations. Using sound recognition technologies, the mobile phone has the capacity to compare the recorded vehicle sound signals to already known noise patterns of different vehicles to determine the type of each nearby vehicle. The mobile phone is therefore able to distinguish the sound signals coming from different vehicles in order to estimate the number of nearby vehicles. After the sounds signals of each vehicle are distinguished, the mobile phone can then analyze the sound signals of each individual vehicle separately. If there is only one microphone, the speed, distance, and the direction of a vehicle can be estimated by analyzing the volume and the spectrum of sound signals coming from the vehicle. If there are two or more microphones, geometry induced timing differences can provide additional information to estimate the approach speed, distance, and the direction of a vehicle with better accuracy. By knowing the type, speed, distance, and direction of each nearby vehicle, the mobile phone can rank the level of potential danger that each vehicle poses, and can provide warnings for the user. The warning messages can be delivered through user interfaces of the mobile phone such as audio messages and/or images, as illustrated by the examples in FIGS. 2(a, b).

While the preferred embodiments have been illustrated and described herein, other modifications and changes will be evident to those skilled in the art. For example, sound signal communications are not only applicable for mobile devices, but also are applicable for systems that control traffic. It is to be understood that there are many other possible modifications and implementations so that the scope of the invention is not limited by the specific embodiments discussed herein.

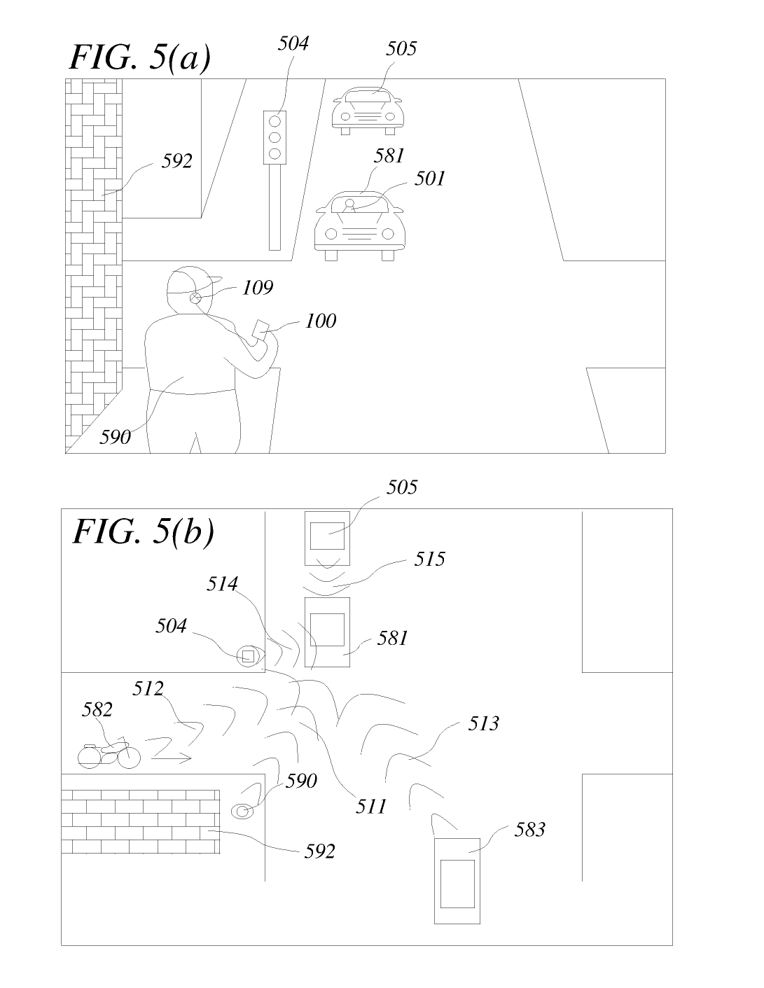

FIG. 5(a) shows a scenario similar to that in FIG. 1(a), but also displays a traffic sign (504) and an additional vehicle (505). In this example, the car closest to the pedestrian (581) is a car driven by a human driver (501), while the car in the back (505) is an autonomous vehicle. The traffic sign (504) in this example is a traffic light, although it can also be a stop sign, street sign, or any other traffic sign previously mentioned.

FIG. 5(b) is a simplified symbolic diagram illustrating a bird's-eye-view of the traffic around the individual in the intersection in FIG. 5(a). An autonomous vehicle (505) is emitting sound signals (515) to detect the vehicle in front of it (581). As a result, it detects the vehicle (581) and stops at the proper distance behind it. The traffic sign (504) is also emitting sound signals (514), and uses active sonar to detect the presence of two vehicles (581 ,505) stopped at the intersection. The natural noises (512, 513) caused by a motorcycle (582) and an approaching vehicle (583) are also detected by the traffic sign (504). Similarly, the pedestrian's cell phone also emits sound signals (511) that can be detected by the traffic sign (504). The traffic sign (504) can then record and analyze all of the sound signals (511-515) and assess nearby traffic conditions in order to determine when to switch lights. In addition, the traffic sign can use the Doppler Effect to calculate the speed of the approaching vehicles, and can assign tickets to the owners of the vehicles if a traffic law is violated. These sound signals (511-515) also can be used by the vehicles (505, 581-583) or the pedestrian's cell phone (100) to assess traffic conditions.

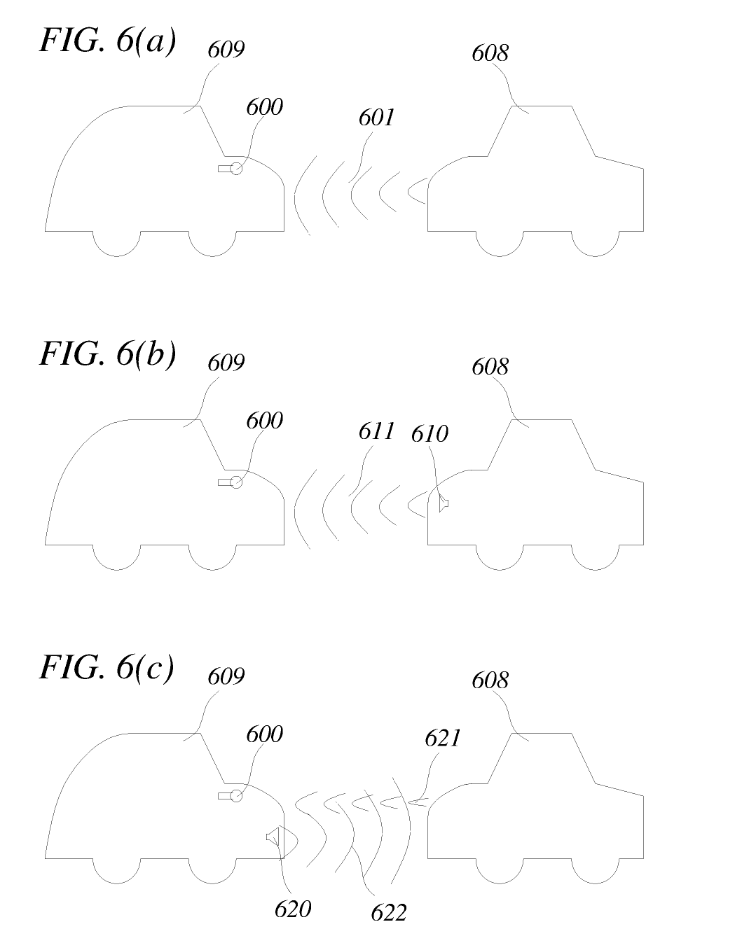

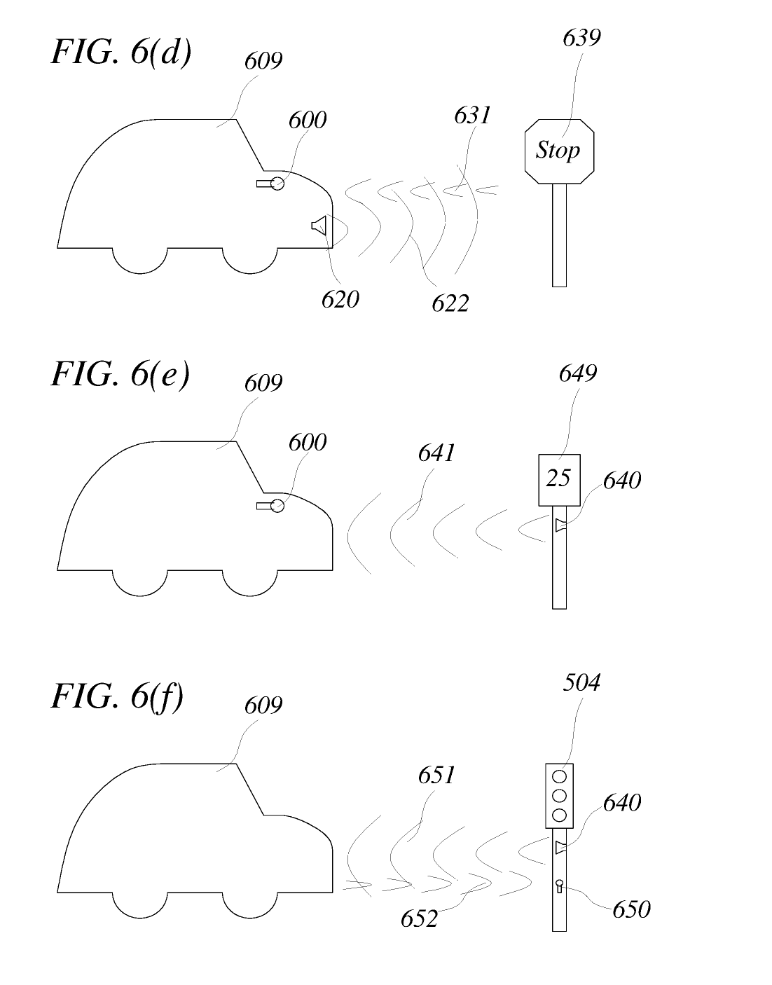

FIGS. 6(a-c) show various methods for vehicle to vehicle communication and vehicle detection. FIG. 6(a) displays a method wherein a sound detecting device (600) is attached to a vehicle (609). Natural noises (601), such as engine noise, air friction, or tire friction, are emitted by a nearby vehicle (608), and the sound detecting device (600) records that noise (601). The recorded noise is then processed and is identified as the noise of a specific model and type of vehicle using methods similar to those disclosed previously. The speed of the nearby vehicle (608) can also be calculated by using the Doppler Effect or other methods such as measuring the change in the volume of the noise. In response, the vehicle with the sound detecting device (609) uses this information to modify its driving.

Alternatively, FIG. 6(b) shows a method wherein the left vehicle (609) uses the sound detecting device (600) to record sound signals (611) emitted by a speaker (610) that is attached to the right vehicle (608). The sound signal (611) can be either amplitude modulated or frequency modulated, and contains identification information specific to the vehicle it is being emitted from (608). When recorded by the sound detecting device, the vehicle then processes the sound, and its driving is then modified based on that sound analysis. FIG. 6(c) shows another method wherein active sonar is used. A sound emitting device (620) emits amplitude or frequency modulated sound signals (622). The emitted sound signals (622) are reflected off of another vehicle (608), and the echoed sound signals (621) are recorded by a sound detecting device (600). This method allows the left vehicle (609) to detect and assess its surroundings. The relative speeds of the vehicles (608, 609) can also be calculated by applying the Doppler Effect to the echoed sound signals (621) or by the timing of the echoed sound waves (621).

While the preferred embodiments have been illustrated and described herein, other modifications and changes will be evident to those skilled in the art. For example, sound signal communication can be applied not only to moving vehicles, but also to immobile structures such as traffic signs. It is to be understood that there are many other possible modifications and implementations so that the scope of the invention is not limited by the specific embodiments discussed herein.

FIGS. 6(d-f) show methods for vehicle to traffic sign communication and detection. FIG. 6(d) shows a method for traffic sign detection for vehicles wherein a vehicle (609) uses active sonar to detect the presence of a traffic sign (639). In this case, the traffic sign (639) is a stop sign. First, a speaker (620) emits sound signals (622). The signals are then reflected off the traffic sign (639), and a sound detecting device (600) records the returning sound signals (631) to determine the distance from the vehicle (609) to the traffic sign (639). FIG. 6(e) shows a method for vehicle to traffic sign communication wherein a speaker (640) that is attached to a traffic sign (649) emits sound signals (641). The sound signals (641) are then recorded by a sound detecting device (600) that is attached to a vehicle (609). The vehicle (609) then processes the recorded sound signals, and its driving is then modified based on the analysis of the recorded sound signal. For this example, the traffic sign (649) is a speed limit sign that broadcasts sound signals (641) to communicate to nearby vehicles that the speed limit is 25 miles per hour. FIG. 6(f) shows a method for vehicle detection for traffic signs wherein the traffic sign (504) uses active sonar to detect the nearby vehicle (609). In this case, the traffic sign (504) is a traffic light. First, a speaker (640) emits sound signals (651). The signals are then reflected off the nearby vehicle (609), and a sound detector (650) records the returning sound signals (652). The sound detector (650) can also detect sounds emitted by nearby vehicles, and the traffic sign (504) then processes the recorded sounds to determine its next action. For example, if the sound detector (650) records the noise of a siren, then the traffic sign (504) can process the recording and quickly switch lights. Similarly, if the sound detector (650) records the noise of a car crash, the traffic sign (504) can process the recording and respond accordingly as well. The traffic sign (504) can identify different vehicles using sound signal communications. For example, upon request of the traffic sign (504), a nearby vehicle can provide their license plate number to the traffic sign using FM or AM sound signals. The traffic sign (504) also can detect violations of traffic rules and assign traffic tickets automatically.

While the preferred embodiments have been illustrated and described herein, other modifications and changes will be evident to those skilled in the art. For example, the traffic sign (649) can be a traffic light that emits sound signals (641) that tell the vehicle (609) the current color of its light. The traffic sign (649) can also be a stop sign that tells the vehicle when to stop or go. A stop sign of the present invention can tell notify the rights of ways to vehicles around it objectively. The traffic sign (649) can also tell the vehicle which specific traffic sign it is, so that the vehicle can determine whether to go straight, left, right, or to U-turn in order to get to its destination. The traffic sign (649) can also provide the names of the streets at the intersection. It is to be understood that there are many other possible modifications and implementations so that the scope of the invention is not limited by the specific embodiments discussed herein.

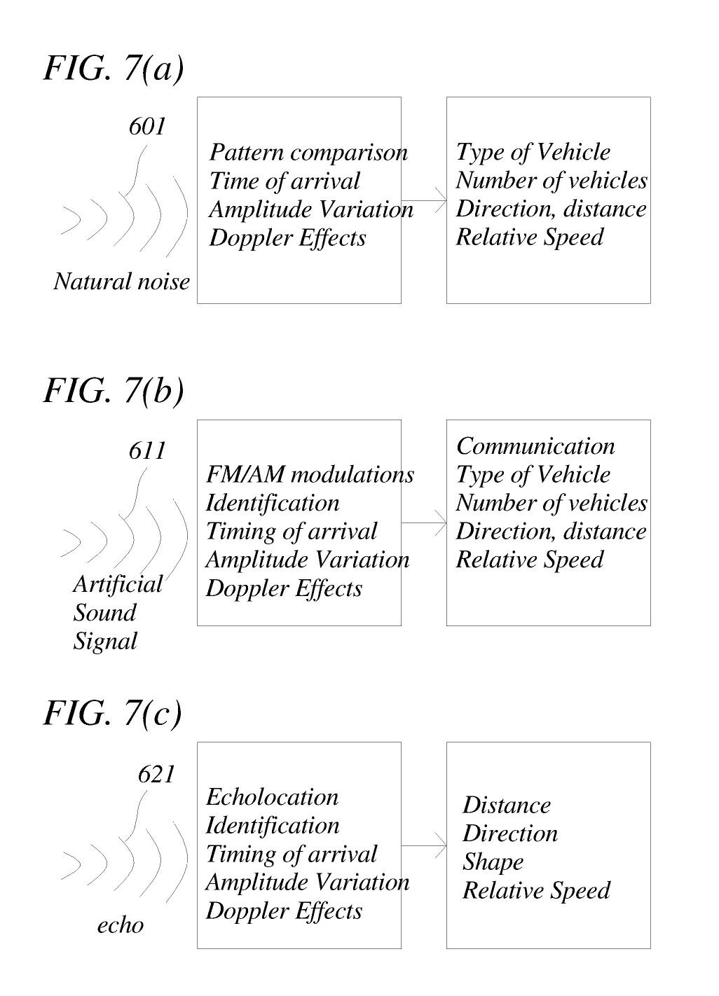

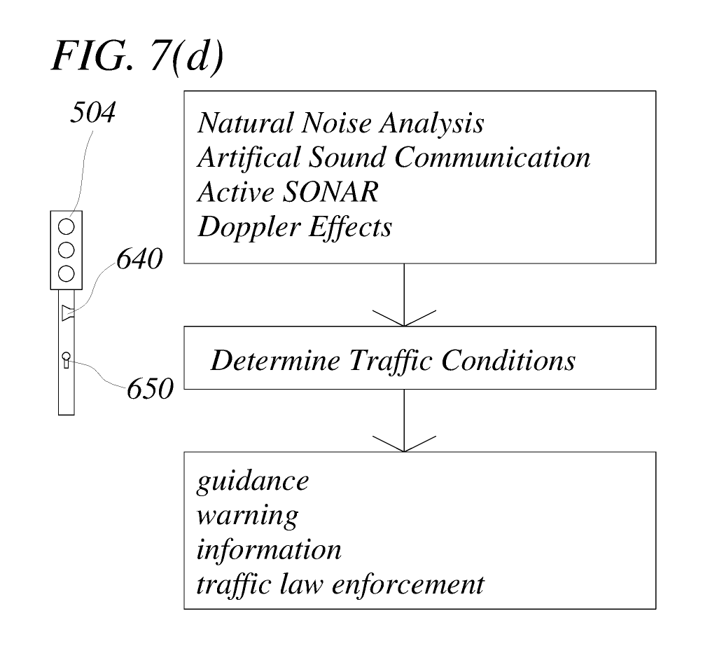

FIG. 7(a) is a simplified flow chart illustrating methods that utilize natural noises (601) emitted by vehicles. The natural noise that a vehicle emits can be engine noise, emission noise, tire friction, air friction, or other sounds. The sounds of horn or siren are not considered as natural sound, but those sounds also can be utilized by embodiments of the present invention. Different types of vehicles have different noise patterns. By comparing the recorded natural noises of nearby vehicles to a database of already known vehicle noise patterns, the types and number of nearby vehicles can be determined. The volume and spectrum of natural noises emitted by vehicles can be used to estimate the speed of, distance from, and direction of nearby vehicles. In addition, an automobile can also estimate the speed of, distance from, and direction of nearby vehicles by comparing the differences between the sound signals detected by different sound detectors. Furthermore, the Doppler Effect can be used to calculate the relative speeds of nearby vehicles.

FIG. 7(b) is a simplified flow chart illustrating the methods for communication between vehicles using artificial sound signals. A vehicle can use an electric sound speaker to transmit sound signals that are in a pre-defined format that both the sender and the receiver understand. For example, an automobile can emit frequency modulated (FM) sound signals with a center frequency of 100 kHz. A sound pulse at a frequency greater than 100 kHz will represent a binary data value of 1, while a sound pulse at a frequency less than 100 kHz will represent a binary data value of 0. As another example, an automobile can emit amplitude modulated (AM) sound signals with a center frequency of 120 kHz. A sound pulse at a relatively higher volume will represent a binary data value of 1, while a sound pulse at a relatively lower volume will represent a binary data value of 0. The emitted artificial sound signals can be either amplitude modulated or frequency modulated. In such ways, the sender can send any information through such artificial sound signals, while the receiver with a sound detector can receive and understand the information. For example, an automobile can emit such artificial sound signals to notify nearby vehicles its identification in license plate number, brand, type, model, current location determined by GPS, destination, current speed, and other types of information. By using such artificial sound signals, two-way communication between vehicles can also be established. The volume variation of artificial sound signals can also be used to estimate the speed of, distance from, and direction of vehicles. In addition, by comparing the differences between the sound signals detected by different sound detectors, the speed of, distance from, and direction of the vehicles that emitted the artificial sound signals can be determined. The Doppler Effect can also be used to calculate the relative speeds of the vehicles that are emitting artificial sound signals. Measurements using artificial sound signals are typically more accurate than measurements using natural noises.

FIG. 7(c) is a simplified flow chart illustrating methods for the application of active sonar. A vehicle can use an electric sound speaker to transmit sound signals that are in a pre-defined format that it is able to identify. For example, an automobile can emit frequency modulated (FM) sound signals with a center frequency of 100 kHz. The sound signal would then be modulated based on an identification code that corresponds to its license plate number. The echo (621) of the emitted sound signal will match the format of the emitted sound waves so that echoed sound signals will be distinguished from other sounds. Active sonar systems can determine the distance from, location of, and shape of nearby objects. An artificial sound signal described in FIG. 7(b) can also be used for active sonar. In addition, the volume variation of echoed sound signals can also be used to estimate the speed of, distance between, and direction of vehicles. Furthermore, by comparing the differences between the echoed sound signals detected by different sound detectors, the speed of, distance from, and direction of nearby objects can also be determined. In addition, when coupled with active sonar, the Doppler Effect can be used to calculate the relative speeds of the objects that the emitted sound signals were echoed off of. Overall, active sonar allows vehicles to detect objects that do not emit sound.

While the preferred embodiments have been illustrated and described herein, other modifications and changes will be evident to those skilled in the art. For example, the methods described in FIGS. 7(a-c) are not only applicable to vehicles, but also are applicable to traffic signs. It is to be understood that there are many other possible modifications and implementations so that the scope of the invention is not limited by the specific embodiments discussed herein.

As illustrated in FIG. 7(d), a traffic sign (504) equipped with sound detector(s) (650), electric sound speaker(s) (640), and sound signal processing capabilities should be able to perform all of the functions illustrated in FIGS. 7(a-c). The traffic sign (504) can analyze the natural sounds emitted by nearby vehicles to determine nearby traffic conditions. In addition, the traffic sign (504) can also incorporate artificial sound communications with nearby vehicles, active sonar systems, and the Doppler Effect to assess nearby traffic conditions. As a result, the traffic sign (504) is therefore able to provide guidance, warning, and information to nearby vehicles. It is also able to enforce traffic laws by communicating with nearby vehicles or assigning traffic tickets to the owners of the vehicles.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

1. A method for automobiles for detecting nearby traffic conditions that comprises the following steps:
record sound signals measured by one or a plurality of sound detectors in the automobile,
use the signal processing capabilities of the automobile to analyze the recorded sound signals to identify sound signals emitted by nearby traffic signs or vehicles,
use the sound signals emitted by nearby traffic signs or vehicles to assess surrounding traffic conditions, and
provide traffic information to direct the driving of the automobile.

2. The method in claim 1 wherein the step of recording sound signals comprises the step of recording sound signals measured by two or more microphones in the automobile.

3. The method in claim 1 wherein the step of using the signal processing capabilities of the automobile to analyze recorded sound signals comprises a step of comparing the recorded sound signals to a database of already known vehicle noise patterns to determine the types of nearby vehicles.

4. The method in claim 1 wherein the step of using the signal processing capabilities of the automobile to analyze recorded sound signals comprises a step of distinguishing sound signals coming from different vehicles in order to estimate the number of nearby vehicles.

5. The method in claim 1 wherein the step of using the signal processing capabilities of the automobile to analyze recorded sound signals comprises a step of using the Doppler Effect to determine the relative speeds of nearby vehicles.

6. The method in claim 1 wherein the step of using the signal processing capabilities of the automobile to analyze recorded sound signals comprises a step of distinguishing sound signals that are in a pre-defined format coming from nearby vehicles.

7. The method in claim 6 wherein the step of using the signal processing capabilities of the automobile to analyze recorded sound signals comprises a step of distinguishing amplitude modulated sound signals coming from nearby vehicles.

8. The method in claim 6 wherein the step of using the signal processing capabilities of the automobile to analyze recorded sound signals comprises a step of distinguishing frequency modulated sound signals coming from nearby vehicles.

9. The method in claim 1 further comprises a step that uses active sonar to transmit a sound signal and detect the echo of the transmitted sound in order to detect the surroundings of the automobile.

10. The method in claim 1 further comprises a step of transmitting a sound signal that is in a pre-defined format for communicating with nearby vehicles or traffic signs.

11. The method in claim 10 comprises a step of transmitting an amplitude modulated sound signal that is in a pre-defined format in order to communicate with nearby vehicles or traffic signs.

12. The method in claim 10 comprises a step of transmitting a frequency modulated sound signal that is in a pre-defined format for communicating with nearby vehicles or traffic signs.

13. The method in claim 1 is implemented on an autonomous automobile.

14. The method in claim 1 further comprises a step of receiving sound signals transmitted by traffic signs.

15. The method in claim 14 comprises a step of receiving amplitude modulated sound signals transmitted by traffic signs.

16. The method in claim 14 comprises a step of receiving frequency modulated sound signals transmitted by traffic signs.

17. A method for detecting nearby traffic conditions for an automobile that comprises the following steps:
transmit sound signals by one or a plurality of sound transmitting devices,
record echoes of said transmitted sound signals measured by one or a plurality of sound detectors in the automobile,
use the signal processing capabilities of the automobile to analyze the recorded echoed sound signals to assess the surroundings of the automobile.

18. The method in claim 17 wherein the step of recording sound signals comprises the step of recording sound signals measured by two or more microphones in the automobile.

19. The method in claim 17 wherein the step of transmitting sound signals comprises a step of including identification information in the transmitted sound signals.

20. The method in claim 17 wherein the step of using the signal processing capabilities of the automobile to analyze echoed sound signals comprises a step of using the Doppler Effect to determine the relative speeds of nearby vehicles.
